(19) United States
(12) Patent Application Publication
(10) Pub. No.: US 2005/0078585 A1
(43) Pub. Date: Apr. 14, 2005

(54) OPTICAL DISC DRIVE WHICH CAN DETECT AND CORRECT BI-PHASE DATA ERRORS

(76) Inventor: Daw-I Wang, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/707,417

(22) Filed: Dec. 12, 2003

(30) Foreign Application Priority Data
Oct. 9, 2003 (TW) 092128171

(51) Int. Cl. G11B 7/00

(52) U.S. Cl. 369/53.35; 369/47.22

(57) ABSTRACT

An optical disc drive includes an optical pickup for reading an RF datum in an optical disc, an FM demodulator for demodulating the RF datum so as to generate a bi-phase datum, a bi-phase data rule checker for checking if phases at each edge of neighboring bit cells are different, a bi-phase data corrector for generating a plurality of bi-phase data when the bi-phase data rule checker detects that at least one pair of phases at the edges of neighboring bit cells are not different, a bi-phase demodulator for demodulating the plurality of bi-phase data so as to generate a plurality of ATIP signals, a CRC checker for testing the plurality of ATIP signals, and a multiplexer for selecting a correct ATIP signal according to a test result of the CRC checker.

### BACKGROUND OF INVENTION

1. Field of the Invention

The present invention relates to an optical disc drive, and more specifically, to an optical disc drive, which can detect errors before a bi-phase data is demodulated and correct the bi-phase data by the principle of exhaustion so that the CRC checker can find the correct data of the optical disc drive.

2. Description of the Prior Art

hen writing a CD-R disc or a CD-RW disc ATIP (Absolute Time In Pre-groove) signals have to be demodulated out for determining a position of an optical pick-up unit on an optical disc. Additionally ATIP signals also have some special information and additional information about the optical disc for burning references.

The original data of ATIP signals are stored on the optical disc in the form of a wobble groove after bi-phase demodulation. And then wobble signals can be derived through an optical pickup and an RF amplifier. Afterwards the ATIP signals can be derived through an FM demodulator and bi-phase demodulator and can be detected by the CRC method. The errors might be ccaused by the following conditions: reading the wrong data because of damage to the optical disc or a problem with the laser strength, or a transmission error due to noise interference or error of the bi-phase demodulation. When finding the wrong data by the CRC method, the optical pickup will read the data again in the prior art, and the data will be transformed into the ATIP signal again. However sometimes the error occurs in the bi-phase demodulating process, so reading the data and transforming the data into the ATIP signal again will not correct the problem. And after the optical pickup reads the data again, the bi-phase demodulating error of the data might occur when the data is being demodulated by the FM demodulator.

### SUMMARY OF INVENTION

It is therefore a primary objective of the present invention to provide an optical disc drive, which can correct a bi-phase data before the bi-phase data is demodulated by the bi-phase demodulator, to solve the problems mentioned above.

Briefly summarized, an optical disc drive includes an optical pickup for reading an RF datum in an optical disc, an FM demodulator for demodulating the RF datum so as to generate a bi-phase datum, a bi-phase data rule checker connected to the FM demodulator for checking if phases at each edge of neighboring bit cells of the bi-phase datum generated by the FM demodulator are different, a bi-phase data corrector connected to the bi-phase data rule checker for generating a plurality of bi-phase data when the bi-phase data rule checker detects that at least one pair of phases at the edges of neighboring bit cells are not different, a bi-phase demodulator connected to the bi-phase data corrector for demodulating the plurality of bi-phase data so as to generate a plurality of ATIP (Absolute Time In Pre-groove) signals, a CRC checker connected to the bi-phase demodulator for testing the plurality of ATIP signals transmitted from the bi-phase demodulator, and a multiplexer connected to the bi-phase demodulator and the CRC checker for selecting a correct ATIP signal transmitted from the bi-phase demodulator according to a test result of the CRC checker.

It is an advantage of the present invention that the bi-phase data rule checker can detect bi-phase demodulating and generate the possible bi-phase data by the principle of exhaustion. The CRC checker can then find the correct ATIP data among the possible ATIP data by the CRC method. Therefore the present invention can improve the accuracy of the ATIP data effectively.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of an optical disc drive of the present invention.

FIG. 2 is a diagram of signals generated before and after being demodulated by an FM demodulator in FIG. 1.

### DETAILED DESCRIPTION

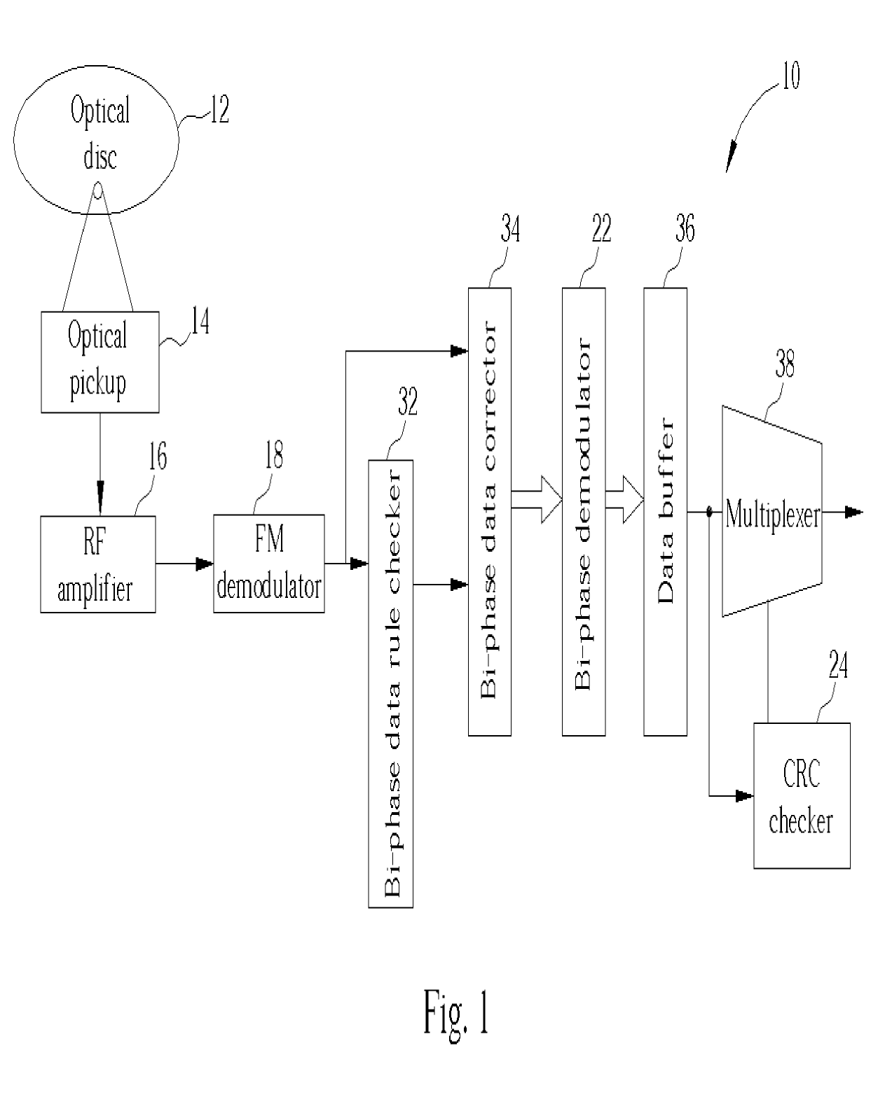

Please refer to FIG. 1. FIG. 1 is a diagram of an optical disc drive 10 of the present invention. The optical disc drive 10 includes an optical disc 12, an optical pickup 14, an RF amplifier 16, an FM demodulator 18, a bi-phase data rule checker 32, a bi-phase data corrector 34, a bi-phase demodulator 22, a data buffer 36, a CRC checker 24, and a multiplexer 38. The optical pickup 14 reads an RF datum in the form of a wobble groove in the optical disc 12 and transmits the RF datum to the RF amplifier 16 for amplifying the RF datum. The FM demodulator 18 can demodulate the RF datum amplified by the RF amplifier 16 in the frequency modulation so as to generate a biphase datum and then transmit the bi-phase datum to the bi-phase data rule checker 32. The bi-phase data rule checker 32 is for checking the bi-phase datum, and if the bi-phase data rule checker detects n phases at each edge of neighboring bit cells of the bi-phase datum are not different, the bi-phase data corrector 34 will generate 2ⁿ different bi-phase data corresponding with the rule that phases at each edge of neighboring bit cells of the bi-phase datum are different. After 2ⁿ different bi-phase data are generated, the 2ⁿ bi-phase data are transmitted to the bi-phase demodulator 22 for being demodulated into a plurality of ATIP signals and temporarily held in the data buffer 36. At last the 2ⁿ ATIP signals stored in the data buffer 36 will be transmitted to the CRC checker 24 for data checking, and multiplexer 38 can select a correct ATIP signal among the 2ⁿ ATIP signals stored in the data buffer 36 according to a test result of the CRC checker 24 and transmit the correct ATIP signal to the next unit.

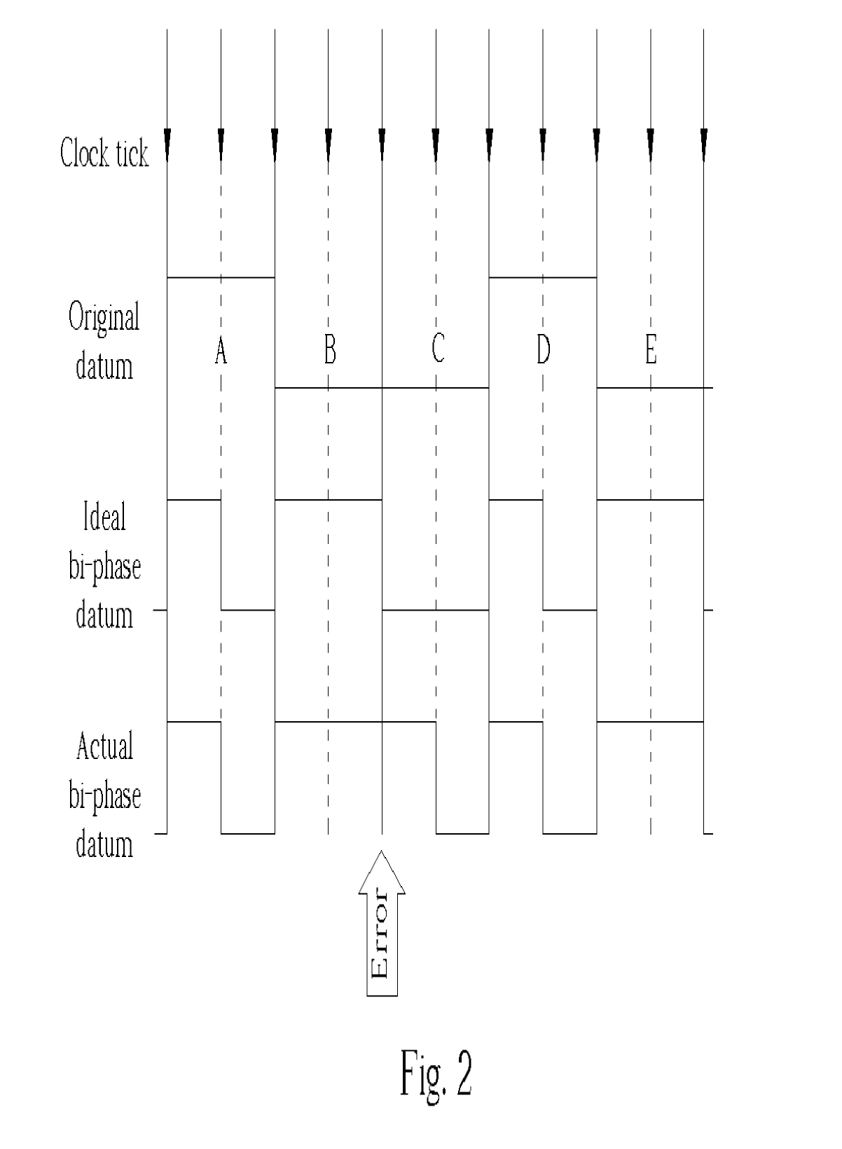

Please refer to FIG. 2. FIG. 2 is a diagram of signals generated before and after being demodulated by the FM de-modulator 18 in FIG. 1. The original datum is the datum not being bi-phase demodulated and FM demodulated yet. The ideal bi-phase datum is the datum that should be generated by the FM demodulator 18 after the FM demodulator 18 demodulates the original datum. The actual bi-phase datum is the datum generated by the FM demodulator 18.

The working principle of the bi-phase demodulation is as follows: A bit cell includes two bi-phase bits. When there is a signal level change between the two bi-phase bits of the bit cell, the demodulating value of the bit cell is “1”; and when there is no signal level change between the two bi-phase bits of the bit cell, the demodulating value of the bit cell is “0”. Besides, there must be a signal level change at each edge of neighboring bit cells. Because the original datum of the bit cell A and the bit cell D is “1”, the ideal bi-phase datum is shown in FIG. 2. After the bit cell A and the bit cell D are demodulated by the FM demodulator 18, there are signal level changes in the bit cell A and the bit cell D. And because the original datum of the bit cell B, the bit cell C, and the bit cell E is “0”, the ideal bi-phase datum is shown in FIG. 2. After the bit cell B, the bit cell C, and the bit cell E are demodulated by the FM demodulator 18, there no signal level changes in the bit cell B, the bit cell C, and the bit cell E. Additionally the ideal bi-phase datum reveals that there must be a signal level change at each edge of neighboring bit cells. However there is no signal level change between the bit cell B and the bit cell C in the actual bi-phase datum shown in FIG. 2. So the bi-phase data rule checker 32 will determine that the bit cell B and the bit cell C are the wrong bit cells. Because there are signal level changes at front and rear edges of the bit cell A, the bit cell D, and the bit cell E in the actual bi-phase datum. The bi-phase data rule checker 32 will determine that the bit cell A, the bit cell D, and the bit cell E are the correct bit cells.

Because whether the second bit of the bit cell B or the first bit of the bit cell C is wrong cannot be decided, and there must be a signal level change at each edge of neighboring bit cells. That is, the first bit of the bit cell B is “1”, and the second bit of the bit cell C is “0”. So the bi-phase data corrector 34 will generate two possible bi-phase data “1010” and “1100” of the bit cell B and the bit cell C and transmit the two possible bi-phase data to the bi-phase demodulator 22 for demodulating into ATIP signals and storing the ATIP signals in the data buffer 36. And then the CRC checker 24 will transmit a selective signal to the multiplexer 38 for selecting the final and correct ATIP signal from the two possible ATIP signals according to the CRC value (“0”). If the CRC value reveals that the correct bi-phase data is “1010”, the multiplexer 38 will output a value “11110” according to the bit cells A to E; and if the CRC value reveals that the correct bi-phase data is “1100”, the multiplexer 38 will output a value “10010” according to the bit cells A to E.

In the above embodiment, a bi-phase datum has five bit cells. But actually every bi-phase datum should have fourteen bit cells. Five bit cells are used in this embodiment for convenience of explanation. Furthermore, if there is one wrong bit of the bi-phase bit cell, the bi-phase corrector 34 will generate two possible bi-phase data. However if there are two wrong bits of the bit cell, the bi-phase corrector 34 will generate four possible bi-phase data because each indistinguishable bit cell has two possible values. That is, if there are n wrong bits of one bi-phase bit cell, the bi-phase corrector 34 will generate 2ⁿ possible bi-phase data.

In contrast to the prior aart in which the optical pickup only reads data on the optical disc again when detecting the wrong demodulating ATIP signal, the present invention can detect errors before the bi-phase is demodulated into the ATIP signal and find the possible bi-phase data by the principle of exhaustion so that the CRC checker can find the correct data from the possible bi-phase data. Therefore the present invention can improve the accuracy of the ATIP data effectively.

Those skilled in the art will readily observe that numerous modifications and alterations of the device and the method may be made while retaining the teachings of the invention. Accordingly, the above disclosure should be construed as limited only by the metes and bounds of the appended claims.

1. An optical disc drive includes:
an optical pickup for reading an RF datum in an optical disc;
an FM demodulator for demodulating the RF datum so as to generate a bi-phase datum;
a bi-phase data rule checker connected to the RF demodulator for checking if phases at each edge of neighboring bit cells of the bi-phase datum generated by the FM demodulator are different;
a bi-phase data corrector connected to the bi-phase data rule checker for generating a plurality of bi-phase data when the bi-phase data rule checker detects that at least one pair of phases at the edges of neighboring bit cells are not different;
a bi-phase demodulator connected to the bi-phase data corrector for demodulating the plurality of bi-phase data so as to generate a plurality of ATIP (Absolute Time In Pre-groove) signals;
a CRC checker connected to the bi-phase demodulator for testing the plurality of ATIP signals transmitted from the bi-phase demodulator; and
a multiplexer connected to the bi-phase demodulator and the CRC checker for selecting a correct ATIP signal transmitted from the bi-phase demodulator according to a test result of the CRC checker.

2. The optical disc drive of claim 1 further comprising an RF amplifier connected to the optical pickup and the FM demodulator for amplifying the RF datum read by the optical pickup.

3. The optical disc drive of claim 1 further comprising a data buffer connected to the bi-phase demodulator and the multiplexer for temporarily holding the plurality of ATIP signals from the bi-phase demodulator.

4. A method for processing data by an optical disc drive, the method comprising:
(a) reading an RF datum in an optical disc;
(b) demodulating the RF datum so as to generate a bi-phase datum;
(c) checking if phases at each edge of neighboring bit cells of the bi-phase datum are different;
(d) if phases at each edge of neighboring bit cells of the bi-phase datum are not different, generating a plurality of bi-phase data corresponding with the rule that phases at each edge of neighboring bit cells of the bi-phase datum are different according to the bi-phase datum;
(e) demodulating the plurality of bi-phase data generated in step (d) so as to generate a plurality of ATIP signals;
(f) testing the plurality of ATIP signals; and
(g) selecting a correct ATIP signal according to a test result in step (f).

5. The method of claim 4 further comprising amplifying the RF datum from the optical disc.

6. The method of claim 4 wherein in step (d) when n phases at each edge of neighboring bit cells of the bi-phase datum are not different, generating a plurality of bi-phase data comprises generating 2ⁿ bi-phase data corresponding with the rule that phases at each edge of neighboring bit cells of the bi-phase datum are different according to the bi-phase datum.

7. The method of claim 4 further comprising after step (e) temporarily holding the plurality of ATIP signals.

8. An apparatus for implementing the method of claim 4.
